(19) United States
(12) Patent Application Publication
(10) Pub. No.: US 2016/0352251 A1
(43) Pub. Date: Dec. 1, 2016

(54) Active Neutral-Point-Clamped (ANPC) Converters and Operating Methods Thereof

(71) Applicant: ABB Technology AG, Zurich (CH)

(72) Inventors: Jun Li, Cary, NC (US); Jing Xu, Cary, NC (US); Li Qi, Cary, NC (US)

(21) Appl. No.: 14/726,587

(22) Filed: May 31, 2015

(51) Int. Cl. H02M 7/487

(52) U.S. Cl. CPC H02M 7/487

(57) ABSTRACT

Five or more level active neutral-point-clamped (ANPC) converters and operating methods thereof are disclosed. The five or more level ANPC converters may include upper and lower DC links, a neutral point, a converter output, a plurality of switching devices including upper and lower active neutral clamp switching devices, and at least one two-level cell connected to the output. Each of the two-level cells may include a floating capacitor and a bidirectional switch. In some examples, switches may be connected between the upper and lower DC links and the corresponding upper and lower active neutral clamp switching devices, and circuit breaking elements may be connected between the neutral point and the upper and lower active neutral clamp switching devices. In some examples, a bidirectional switch may be connected in parallel with each of the plurality of switching devices other than the upper and lower active neutral clamp switching devices.

### FIELD OF THE DISCLOSURE

The present disclosure relates to electrical power converters, and more particularly to active neutral-point-clamped (ANPC) converters.

### BACKGROUND

Examples of converter circuits for switching a large number of switching voltage levels are disclosed in U.S. Pat. No. 7,292,460. The complete disclosure of this and all other publications referenced herein are hereby incorporated by reference in their entirety for all purposes. A nonexclusive illustrative example of a five-level ANPC (“5L-ANPC”) converter, which comprises a single phase leg, is shown generally at 20 in FIG. 1, and is hereinafter referred to as the 5L-ANPC converter 20.

Additional nonexclusive illustrative examples of “5L-ANPC” converters are shown in “ANPC-5L Technology Applied to Medium Voltage Variable Speed Drives Applications” by F. Kiefendorf, et al., which was published in the 2010 International Symposium on Power Electronics Electrical Drives Automation and Motion (SPEEDAM), at pages 1718-1725, and in “Active-Neutral-Point-Clamped (ANPC) Multilevel Converter Technology” by P. Barbosa, et al., which was published at the EPE 2005 conference in Dresden, Germany, at pages 1-10.

The 5L-ANPC converter 20 includes upper and lower direct current (“DC”) links 22, 24; upper and lower DC link capacitors 26, 28; a neutral point 30; a converter output 32; a floating capacitor 34; a two-level cell 36 that is connected to the converter output 32; and a plurality of switching devices SD1, SD2, SD3, SD4, SD5, SD6, SD7 and SD8. The two-level cell 36 comprises the switching devices SD1 and SD2 and the floating capacitor 34.

As used herein, the “upper” sides of the illustrated nL-ANPC converters should be understood as the electrical “side” or portion of the converter that is connected to the converter's upper DC link, which has a positive DC input voltage (+V) relative to the neutral point of the converter, while the “lower” sides of the illustrated nL-ANPC converters should be understood as the electrical “side” or portion of the converter that is connected to the converter's lower DC link, which has a negative DC input voltage (−V) relative to the neutral point of the converter. In the 5L-ANPC converter 20, the upper DC link 22 corresponds to a positive DC input voltage (+V) relative to the neutral point 30, while the lower DC link 24 corresponds to a negative DC input voltage (−V) relative to the neutral point 30. The “upper” side of the 5L-ANPC converter 20 comprises the upper DC link 22, the neutral point 30, the upper DC link capacitor 26, and the switching devices SD1, SD3, SD5 and SD6. The “lower” side of the 5L-ANPC converter 20 comprises the lower DC link 24, the neutral point 30, the lower DC link capacitor 28, and the switching devices SD2, SD4, SD7 and SD8.

As shown in FIG. 1, each of the switching devices SD1, SD2, SD3, SD4, SD5, SD6, SD7 and SD8 of the illustrated 5L-ANPC converter 20 may respectively include a corresponding insulated-gate bipolar transistor (“IGBT”) T1, T2, T3, T4, T5, T6, T7 and T8 and a corresponding anti-parallel freewheeling diode D1, D2, D3, D4, D5, D6, D7 and D8.

The various components of the 5L-ANPC converter 20 are connected together as shown in FIG. 1, with the various terminals of the switching devices SD1-SD8 being connected as generally set forth below. As the various switching devices SD1-SD8 of the illustrated 5L-ANPC converter 20 comprise IGBTs, the connections of the switching devices SD1-SD8 are described with reference to the collector and emitter terminals of the corresponding IGBTs T1-T8 of the switching devices SD1-SD8.

Within the two-level cell 36, the floating capacitor 34 has a first terminal that is connected to the collector of the upper switching device of the two-level cell 36 (switching device SD1) and a second terminal that is connected to the emitter of the lower switching device of the two-level cell 36 (switching device SD2). The emitter of switching device SD1 and the collector of switching device SD2 are both connected to the converter output 32.

On the “upper” side of the 5L-ANPC converter 20, the emitter of switching device SD3 is connected to the collector of switching device SD1 and the first terminal of the floating capacitor 34. The collector of switching device SD3 is connected to both the emitter of switching device SD5 and the collector of switching device SD6. The collector of switching device SD5 is connected to the upper DC link 22. The emitter of switching device SD6 (the upper active neutral clamp switching device) is connected to the neutral point 30. The upper DC link capacitor 26 is connected between the upper DC link 22 and the neutral point 30.

On the “lower” side of the 5L-ANPC converter 20, the collector of switching device SD4 is connected to the emitter of switching device SD2 and the second terminal of the floating capacitor 34. The emitter of switching device SD4 is connected to both the emitter of switching device SD7 and the collector of switching device SD8. The emitter of switching device SD8 is connected to the lower DC link 24. The collector of switching device SD7 (the lower active neutral clamp switching device) is connected to the neutral point 30. The lower DC link capacitor 28 is connected between the lower DC link 24 and the neutral point 30.

The switching states of the 5L-ANPC converter 20 are listed in the Table 37 that is shown in FIG. 2. There are eight switching states V0, V1, V2, V3, V4, V5, V6 and V7 for the 5L-ANPC converter 20, with phase redundant switching states (RSSs) V5/V6 and V1/V2. The eight switching states V0-V7 may be used to produce a five-level output voltage waveform that has five different voltage levels: V (which corresponds to the voltage at the upper DC link or half of the DC link voltage), V/2, 0 (the voltage at the neutral point), −V/2, and −V (which corresponds to the voltage at the lower DC link).

For each of the eight switching states V0-V7, Table 37 sets forth the gate signals that are to be sent to the IGBTs T1-T8 of the switching devices SD1-SD8, where “1” indicates that an “ON” signal is sent to the device gate such that the IGBT passes current and “0” indicates that an “OFF” signal is sent to the device gate such that the IGBT does not pass current (although the corresponding anti-parallel diode would still pass current). For example, in the switching state V7, an “ON” signal is sent to the device gate of the IGBTs T1, T3, T5 and T7 while an “OFF” signal is sent to the device gates of the IGBTs T2, T4, T6 and T8, which results in an output voltage of “V” at the converter output 32. In the switching state V2, an “ON” signal is sent to the device gate of the IGBTs T2, T3, T6 and T8 while an “OFF” signal is sent to the device gates of the IGBTs T1, T4, T5 and T7, which results in an output voltage of “−V/2” at the converter output 32.

As may be understood, certain switching states may result in charging or discharging of the floating capacitor 34, depending on whether or not the current “Ip” flowing out from the converter output 32 is less than or greater than zero. In Table 37, charging of the floating capacitor 34 is indicated by a “+” in the “Effect on floating capacitor” columns, while discharging is indicated by a “−.” For example, in the switching state V6, the floating capacitor is charging when the current Ip flowing from the converter output 32 is greater than zero and discharging when the current Ip flowing from the converter output 32 is less than zero.

As may be understood, m examples of any of the converters disclosed herein, may be incorporated into an m-phase converter. For example, as shown in FIG. 3, three examples of the 5L-ANPC converter 20, which comprises only a single phase leg, may be connected to a common DC link 40 to form a three phase converter 42, with the upper DC link 22 of each of the 5L-ANPC converters 20 being connected to a common upper DC link 44 and the lower DC link 24 of each of the 5L-ANPC converters 20 being connected to a common lower DC link 46.

### SUMMARY

In some examples, a five or more level ANPC converter may include upper and lower DC links, a neutral point, a converter output, at least one two-level cell connected to the converter output, an upper active neutral clamp switching device having a first terminal, and a lower active neutral clamp switching device having a second terminal. Each of the at least one two-level cells may include a floating capacitor and a bidirectional switch connected in series with the floating capacitor. A first switch may be connected between the upper DC link and the first terminal, and a first circuit breaking element may be connected between the first terminal and the neutral point. A second switch may be connected between the lower DC link and the second terminal, and a second circuit breaking element may be connected between the second terminal and the neutral point.

In some examples, a five or more level ANPC converter may include upper and lower DC links, a neutral point, a converter output, at least one two-level cell connected to the converter output, upper and lower active neutral clamp switching devices each coupled to the neutral point, and a plurality of other switching devices in addition to the upper and lower active neutral clamp switching devices. Each of the at least one two-level cell may include a floating capacitor and a first bidirectional switch connected in series with the floating capacitor. A second bidirectional switch may be connected in parallel with each of the plurality of other switching devices.

In some examples, methods of operating a five or more level ANPC converter, such as one that includes upper and lower DC links, a neutral point, a converter output, at least one two-level cell connected to the converter output, a plurality of switching devices including upper and lower active neutral clamp switching devices coupled to the neutral point, the plurality of switching devices including a plurality of other switching devices in addition to the upper and lower active neutral clamp switching devices, and each of the at least one two-level cell comprises a floating capacitor and a bidirectional switch connected in series with the floating capacitor, may include identifying at least one of the plurality of switching devices as having a failure. The method may further include at least one of selectively controlling the bidirectional switch to selectively disconnect the floating capacitor, disconnecting the upper active neutral clamp switching device from the neutral point if the failure is a short failure of the upper active neutral clamp switching device, disconnecting the lower active neutral clamp switching device from the neutral point if the failure is a short failure of the lower active neutral clamp switching device, and short-circuiting the identified at least one of the plurality of switching devices if the failure is an open failure of at least one of the plurality of other switching devices.

### BRIEF DESCRIPTION OF DRAWINGS

FIG. 1 is a schematic diagram of a nonexclusive illustrative example of a 5L-ANPC converter.

FIG. 2 is a table showing the switching states for the 5L-ANPC converter of FIG. 1.

FIG. 3 is a schematic diagram of a nonexclusive illustrative example of a three phase 5L-ANPC converter.

FIG. 4 is a schematic diagram of a nonexclusive illustrative example of a 5L-ANPC converter, configured for device-short-failure tolerance.

FIG. 5 is a nonexclusive illustrative example of a bidirectional switch suitable for use as the switch Sc4 in the 5L-ANPC converter of FIG. 4.

FIG. 6 is a table showing the switching states for the 5L-ANPC converters of FIGS. 4, 9 and 11 in response to various switching device failures.

FIG. 7 is a three-phase voltage vector diagram for a fault tolerant 5L-ANPC converter, such as the 5L-ANPC converters of FIGS. 4, 9 and 11.

FIG. 8 is a schematic diagram of a nonexclusive illustrative example of a seven-level ANPC (“7L-ANPC”) converter, configured for device-short-failure tolerance.

FIG. 9 is a schematic diagram of a nonexclusive illustrative example of another 5L-ANPC converter, configured for device-open-failure tolerance.

FIG. 10 is a schematic diagram of a nonexclusive illustrative example of another 7L-ANPC converter, configured for device-open-failure tolerance.

FIG. 11 is a schematic diagram of a nonexclusive illustrative example of another 5L-ANPC converter, configured for both device-open- and device-short-failure tolerance.

FIG. 12 is a schematic diagram of a nonexclusive illustrative example of another 7L-ANPC converter, configured for both device-open- and device-short-failure tolerance.

### DETAILED DESCRIPTION

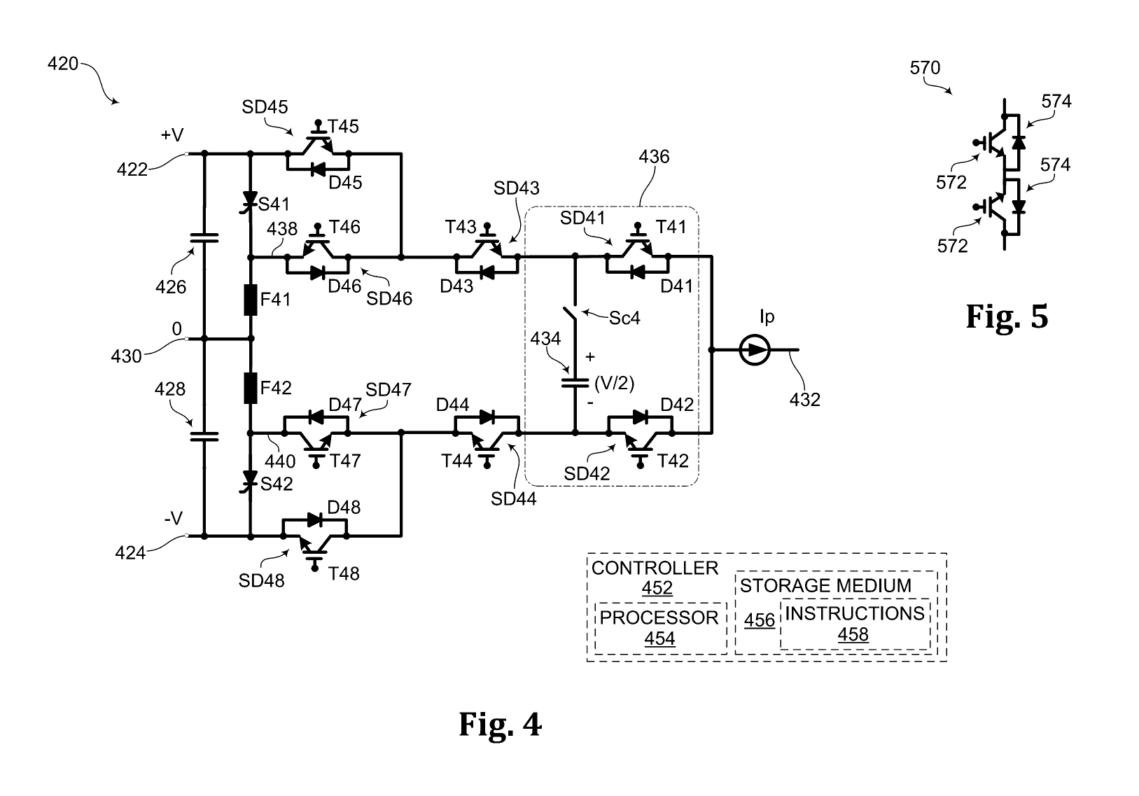

A nonexclusive illustrative example of a 5L-ANPC converter is shown generally at 420 in FIG. 4. Although the 5L-ANPC converter 420 shown in FIG. 4 comprises only a single phase leg, other examples of 5L-ANPC converters may include one or more additional phase legs, each of which may be similar to the 5L-ANPC converter 420, or m examples of the 5L-ANPC converter 420 may be incorporated into an m-phase converter. Unless otherwise specified, the 5L-ANPC converter 420 may, but is not required to, contain at least one of the structures, components, functionalities, and/or variations described, illustrated, and/or incorporated herein.

In the illustrated example, the 5L-ANPC converter 420 includes upper and lower DC links 422, 424; upper and lower DC link capacitors 426, 428; a neutral point 430; a converter output 432; a two-level cell 436 that is connected to the converter output 432; first and second switches S41, S42; first and second circuit breaking elements F41, F42; and a plurality of switching devices SD41, SD42, SD43, SD44, SD45, SD46, SD47 and SD48. As shown in FIG. 4, the switching device SD46 is the upper active neutral clamp switching device, and the switching device SD47 is the lower active neutral clamp switching device. The two-level cell 436 comprises the switching devices SD41 and SD42, a floating capacitor 434 and a bidirectional switch Sc4.

In the 5L-ANPC converter 420, the upper DC link 422 corresponds to a positive DC input voltage (+V) relative to the neutral point 430, while the lower DC link 424 corresponds to a negative DC input voltage (−V) relative to the neutral point 430. The “upper” side of the 5L-ANPC converter 420 comprises the upper DC link 422, the upper DC link capacitor 426, the neutral point 430, the first switch S41, the first circuit breaking element F41, and the switching devices SD41, SD43, SD45 and SD46. The “lower” side of the 5L-ANPC converter 420 comprises the lower DC link 424, the lower DC link capacitor 428, the neutral point 430, the second switch S42, the second circuit breaking element F42, and the switching devices SD42, SD44, SD47 and SD48.

As shown in FIG. 4, each of the plurality of switching devices SD41, SD42, SD43, SD44, SD45, SD46, SD47 and SD48 of the illustrated 5L-ANPC converter 420 may respectively comprise a corresponding IGBT T41, T42, T43, T44, T45, T46, T47 and T48 and a corresponding anti-parallel freewheeling diode D41, D42, D43, D44, D45, D46, D47 and D48.

The various components of the 5L-ANPC converter 420 are connected together as shown in FIG. 4, with the various terminals of the switching devices SD41-SD48 being connected as generally set forth below. As the various switching devices SD41-SD48 of the illustrated 5L-ANPC converter 420 comprise IGBTs, the connections of the switching devices SD41-SD48 are described with reference to the collector and emitter terminals of the corresponding IGBTs T41-T48 of the switching devices SD41-SD48. As will be understood by persons of skill in the art, the switching devices SD41-SD48 may include power semiconductor switching devices or active elements other than IGBTs, such as power MOSFETs (metal-oxide-semiconductor field-effect transistors) or integrated gate-commutated thyristors (“IGCTs”), in which case the references below to “collector” and “emitter” would be changed to the appropriate corresponding terminal of such other active elements.

Within the two-level cell 436, the bidirectional switch Sc4 and the floating capacitor 434 are connected in series between the collector of the upper switching device of the two-level cell 436 (switching device SD41) and the emitter of the lower switching device of the two-level cell 436 (switching device SD42). The emitter of switching device SD41 and the collector of switching device SD42 are both connected to the converter output 432.

On the “upper” side of the 5L-ANPC converter 420, the emitter of switching device SD43 is connected to the collector of switching device SD41. The collector of switching device SD43 is connected to both the emitter of switching device SD45 and the collector of switching device SD46. The collector of switching device SD45 is connected to the upper DC link 422. The emitter (first terminal 438) of the upper active neutral clamp switching device (switching device SD46) is connected to the neutral point 430 by the first circuit breaking element F41 and to the upper DC link 422 by the first switch S41. The upper DC link capacitor 426 is connected between the upper DC link 422 and the neutral point 430. The first switch S41 and the first circuit breaking element F41 are connected in series between the upper DC link 422 and the neutral point 430, with the first switch S41 and the first circuit breaking element F41 being together connected in parallel with the upper DC link capacitor 426.

On the “lower” side of the 5L-ANPC converter 420, the collector of switching device SD44 is connected to the emitter of switching device SD42. The emitter of switching device SD44 is connected to both the emitter of switching device SD47 and the collector of switching device SD48. The emitter of switching device SD48 is connected to the lower DC link 424. The collector (second terminal 440) of the lower active neutral clamp switching device (switching device SD47) is connected to the neutral point 430 by the second circuit breaking element F42 and to the lower DC link 424 by the second switch S42. The lower DC link capacitor 428 is connected between the lower DC link 424 and the neutral point 430. The second switch S42 and the second circuit breaking element F42 are connected in series between the lower DC link 424 and the neutral point 430, with the second switch S42 and the second circuit breaking element F42 being together connected in parallel with the lower DC link capacitor 428.

The first and second switches S41, S42 may be any suitable type of normally open switch. In some examples, at least one of the first and second switches S41, S42 may comprise a thyristor, such as a gate turn-off thyristor (“GTO”), or a semiconductor-controlled rectifier (“SCR”).

The first and second circuit breaking elements F41, F42 may be any suitable type of circuit breaking element. In some examples, at least one of the first and second circuit breaking elements F41, F42 may comprise a fuse.

The bidirectional switch Sc4 may be any suitable type of switch that may selectively pass current in either direction, such as a semiconductor device with low losses. A nonexclusive illustrative example of a suitable bidirectional switch is shown generally at 570 in FIG. 5. The bidirectional switch 570 includes two IGBTs 572 connected in opposite directions, with each of the IGBTs including an anti-parallel diode 574. Another nonexclusive illustrative example of a bidirectional switch suitable for use as the bidirectional switch Sc4 would be a reverse blocking IGBT (“RB-IGBT”).

As generally set forth below, the 5L-ANPC converter 420 may provide a fault-tolerant topology having a tolerance with regard to short-failures or short-failure conditions of one or more of its semiconductor switching devices. By “fault-tolerant,” it is meant that the converter may continue operating despite having one or more failed switching devices, as opposed to the converter being shut down upon detection of a failed switching device within the converter. As used herein, “short-failure” or “short-failure condition” of a semiconductor switching device means that the failed device passes current in both directions.

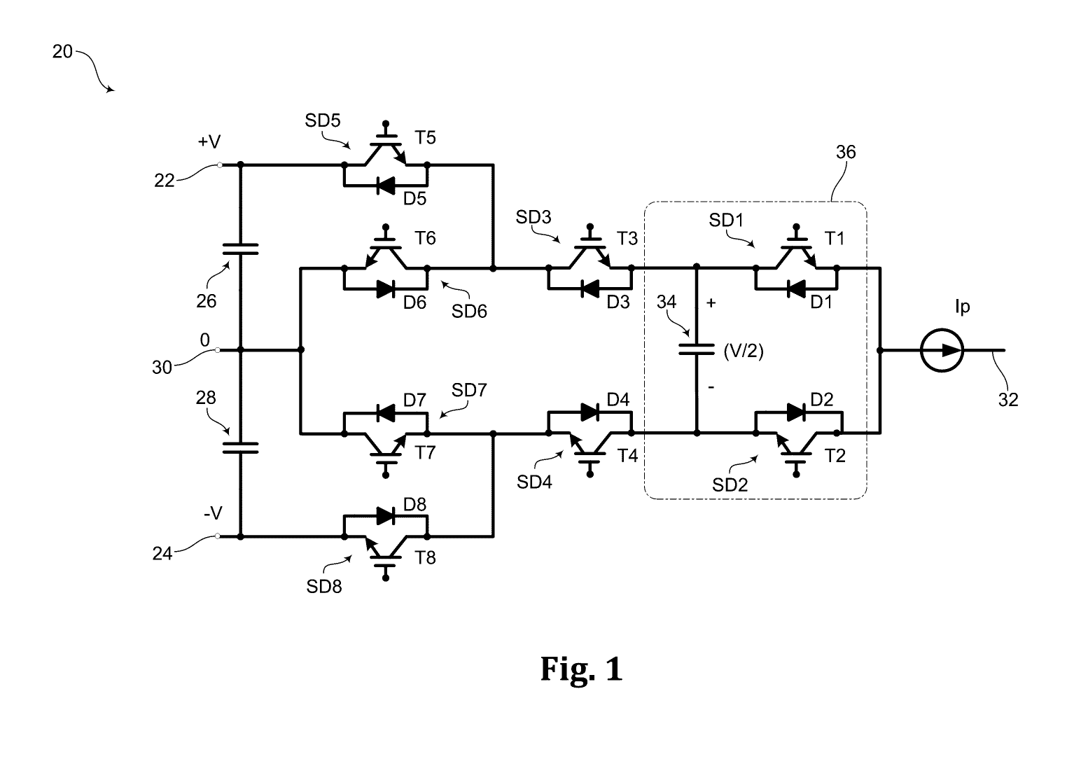

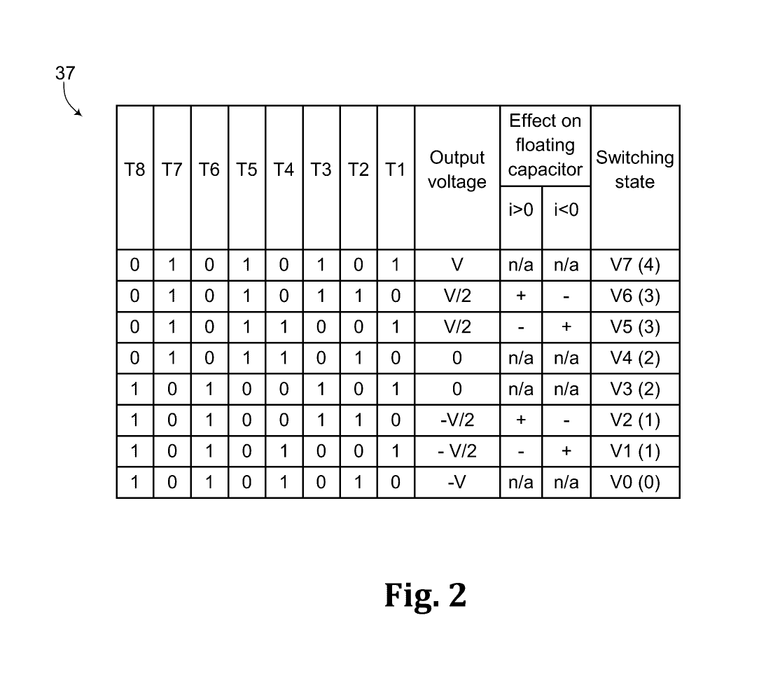

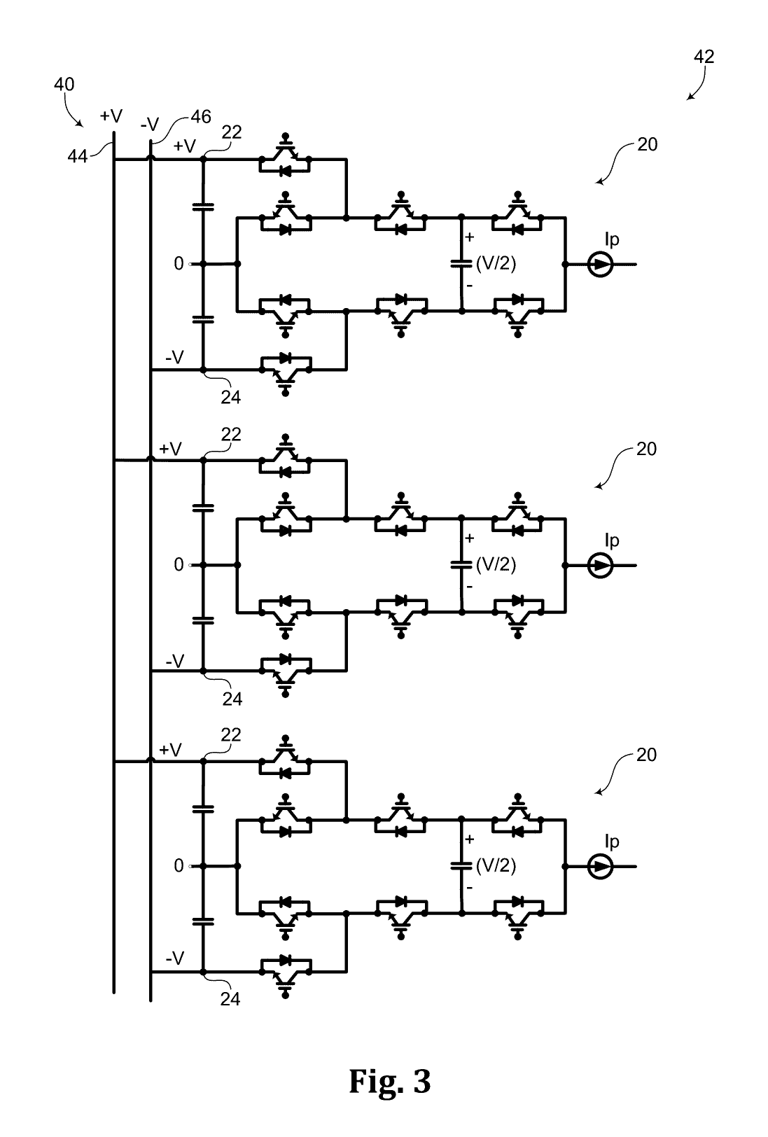

In normal operation, the bidirectional switch Sc4 is in the “ON” (closed) state, and the 5L-ANPC converter 420 may generally function as described above with regard to the 5L-ANPC converter 20 shown in FIG. 1.

In response to a short-failure of either the IGBT T46 or the anti-parallel freewheeling diode D46 of the upper active neutral clamp switching device (switching device SD46), the first switch S41 may be closed to cause the first circuit breaking element F41 to open and disconnect the upper active neutral clamp switching device (switching device SD46) from the neutral point 430. If the first circuit breaking element F41 includes a fuse, the first switch S41 is closed to blow the fuse.

In response to a short-failure of either the IGBT T47 or the anti-parallel freewheeling diode D47 of the lower active neutral clamp switching device (switching device SD47), the second switch S42 may be closed to cause the second circuit breaking element F42 to open and disconnect the lower active neutral clamp switching device (switching device SD47) from the neutral point 430. If the second circuit breaking element F42 includes a fuse, the second switch S42 is closed to blow the fuse.

In response to a short-failure of one of the switching devices SD41-SD48, the bidirectional switch Sc4 may be selectively opened to selectively connect or disconnect the floating capacitor 434 to provide a selected voltage at the converter output 432.

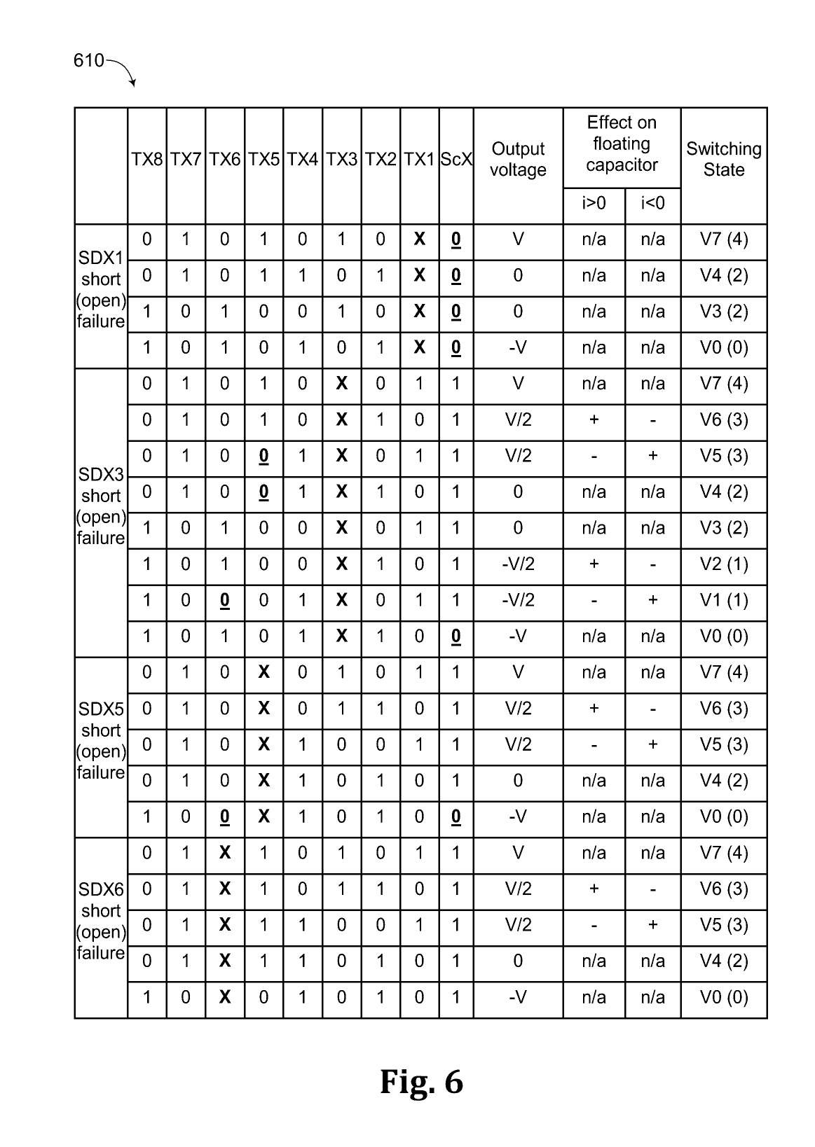

The modified switching states for the 5L-ANPC converter 420 in response to a short-failure of one of the “upper” side switching devices SD41, SD43, SD45 and SD46 are listed in the Table 610 that is shown in FIG. 6, where SDX1, SDX3, SDX5 and SDX6 in Table 610 respectively correspond to the switching devices SD41, SD43, SD45 and SD46 of the 5L-ANPC converter 420. As may be understood, in view of the symmetric structure of the 5L-ANPC converter 420, failures of “lower” side switching devices (i.e., the switching devices SD42, SD44, SD47 and SD48) may be addressed in a manner generally corresponding to what is described with regard to failures of the corresponding upper side switching devices (i.e., SD41 for SD42, SD43 for SD44, SD45 for SD48 and SD46 for SD47).

The Table 610 sets forth the gate signals that are to be sent to the IGBTs T41-T48 of the switching devices SD41-SD48, where TX1, TX2, TX3, TX4, TX5, TX6, TX7 and TX8 in Table 610 respectively correspond to the IGBTs T41, T42, T43, T44, T45, T46, T47 and T48 in the 5L-ANPC converter 420. In Table 610, “1” indicates that an “ON” signal is sent to the device gate such that the IGBT passes current and “0” indicates that an “OFF” signal is sent to the device gate such that the IGBT does not pass current (although the corresponding anti-parallel diode would still pass current).

In Table 610, the gate signals for the failed-in-short device is indicated as “X” because the devices failed in short will pass current in both directions, regardless of whether an “ON” signal is sent to the device gate, an “OFF” signal is sent to the device gate or no control signal is sent to the device gate. However, as noted above, when the switching device SD46 fails in short, the first switch S41 may be closed to cause the first circuit breaking element F41 to open and disconnect the switching device SD46 from the neutral point 430 so that the switching device SD46 will not pass current in either direction.

In Table 610, a “0” (an underlined zero) for one of the IGBTs T41-T48 indicates that an “OFF” signal is sent to the device gate of that IGBT in response to a short failure as opposed to the “ON” signal that would have been sent to the device gate of that IGBT during normal operation (as set forth in Table 37).

For the bidirectional switch Sc4 in the 5L-ANPC converter 420, a “0” (an underlined zero) in Table 610 for ScX, which corresponds to the bidirectional switch Sc4 in the 5L-ANPC converter 420, indicates that bidirectional switch Sc4 is open so that it does not pass current in either direction, while a “1” indicates that bidirectional switch Sc4 is closed so that it passes current in both directions. If the bidirectional switch Sc4 comprises the bidirectional switch 570 shown in FIG. 5, a “0” (an underlined zero) in Table 610 indicates that an “OFF” signal is sent to the device gates of both IGBTs 572 such that the bidirectional switch 570 does not pass current in either direction, while a “1” indicates that an “ON” signal is sent to the device gates of both IGBTs 572 such that the bidirectional switch 570 can pass current in both directions.

As may be observed from Table 610, depending on which of the switching devices SD41-SD48 has failed, some or all of the original eight switching states V0, V1, V2, V3, V4, V5, V6 and V7 (as shown in Table 37) may still be available for the 5L-ANPC converter 420. For example, if the switching device SD43 has failed, all eight of the switching states (and the corresponding five output voltage levels) remain available. However, if one of the switching devices SD41, SD45 or SD46 fails, a reduced number of switching states may still be available along with a reduced number of available output voltages.

As may be understood from Table 610, the illustrated 5L-ANPC converter 420 can still generate an output voltage of +V, 0 or −V after a short failure of any one of the switching devices SD41, SD43, SD45 or SD46. However, floating capacitor voltage regulation will be available when an output voltage of V/2 voltage is generated if both phase RSSs V5 and V6 are still available in the 5L-ANPC converter 420 after a short failure of one of the switching devices (e.g., as with a short failure of one of switching devices SD43, SD45 or SD46). Floating capacitor voltage regulation will be available when an output voltage of −V/2 is generated if both phase RSSs V1 and V2 are still available in the 5L-ANPC converter 420 after a short failure of one of the switching devices (e.g., as with a short failure of switching device SD43).

As may be understood from Table 610, under a short failure of the switching device SD43, the switching state V1 (to generate an output voltage of −V/2) results in the switching device SD45 blocking a voltage of 3V/2 (2V−V/2) instead of V. Accordingly, the switching device SD45 should be rated for 3V/2 if the illustrated 5L-ANPC converter 420 is to provide the switching state V1 under a short failure of the switching device SD43. Thus, if the switching device SD43 fails in short, switching device SD45 should be rated for 3V/2 or the switching states V1 and V2 in Table 610 should be avoided after a short failure of the switching device SD43.

Under a short failure of the switching device SD45, the switching state V0 (to generate an output voltage of −V) results in the switching device SD43 and the bidirectional switch Sc4 blocking a total voltage of 3V/2 (2V−V/2). If the switching device SD43 is rated for V/2, the bidirectional switch Sc4 should be rated for V if the 5L-ANPC converter 420 is to provide the switching state V0 under a short failure of the switching device SD45.

With regard to control of the bidirectional switch Sc4 in the 5L-ANPC converter 420 after a short failure of one of the switching devices SD41-SD48, if there is no current flow through the floating capacitor 434 in a particular modified switching state, then the bidirectional switch Sc4 main either remain closed, as in normal operation, or it may be opened. Thus, for example, if the switching device SD41 fails in short, the bidirectional switch Sc4 may be open, as indicated by the “0” (an underlined zero) in Table 610 for ScX, or closed for the available switching states V0, V3, V4 and V7.

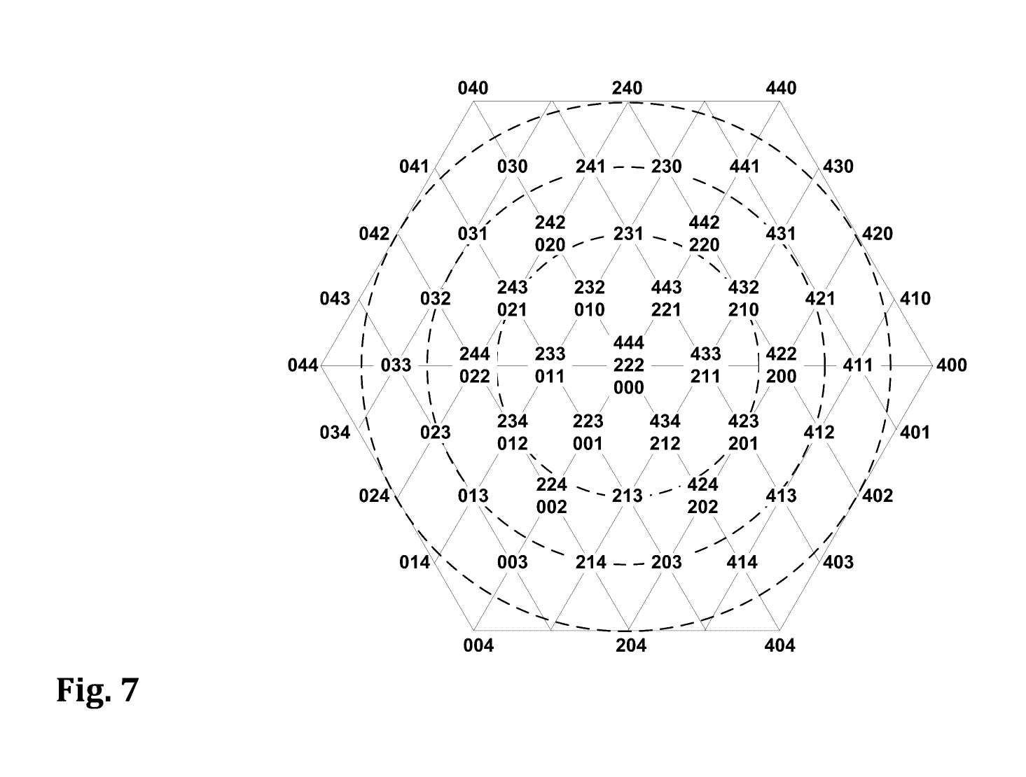

The available voltage vectors and switching states of the 5L-ANPC converter 420 during fault tolerant operation are shown in FIG. 7. As observed, some line-to-line RSSs of voltage vectors are lost. However 57 of the 61 voltage vectors are still available, with only 4 of them being lost. This means the 5L-ANPC converter 420 can still generate a 9-level line-to-line voltage waveform and achieve the maximum modulation index as normal operation. Moreover, V/2 and/or −V/2 may also be available depending on the location of the failed device, which indicates more voltage vectors and RSSs availability in FIG. 7 and potential converter performance improvement in terms of harmonics, power losses, neutral point regulation, etc.

Furthermore, the 5L-ANPC converter 420 may be able to achieve continuous and symmetrical sinusoidal output currents, and maintain the floating capacitor 434 and DC-link neutral point balance under at least some switching device failures. Additionally, the voltage and power rating of the 5L-ANPC converter 420 may not need to be derated when operating with failed devices such that the same maximum output voltage may be maintained. In some examples, waveform quality may be improved by modifying the modulation scheme when operating with failed devices.

In some examples, the 5L-ANPC converter 420 may be associated with or include a suitable controller, such as the nonexclusive illustrative example controller 452 shown in FIG. 4, which includes at least one processor 454, at least one non-transitory computer readable storage medium 456 and a plurality of machine-readable instructions 458 stored on the storage medium 456 and configured to be executed by the at least one computer processor 454 such that the controller 452 may send appropriate control signals to various ones of the switching devices SD41-SD48; the first and second switches S41, S42 and/or the bidirectional switch Sc4 so as to operate the 5L-ANPC converter 420. As a nonexclusive illustrative example, in response to a short failure of one of the switching devices SD41-SD48, the controller 452 may be configured to send appropriate control signals to at least one of the first switch S41, the second switch S42, and/or the bidirectional switch Sc4, as outlined above.

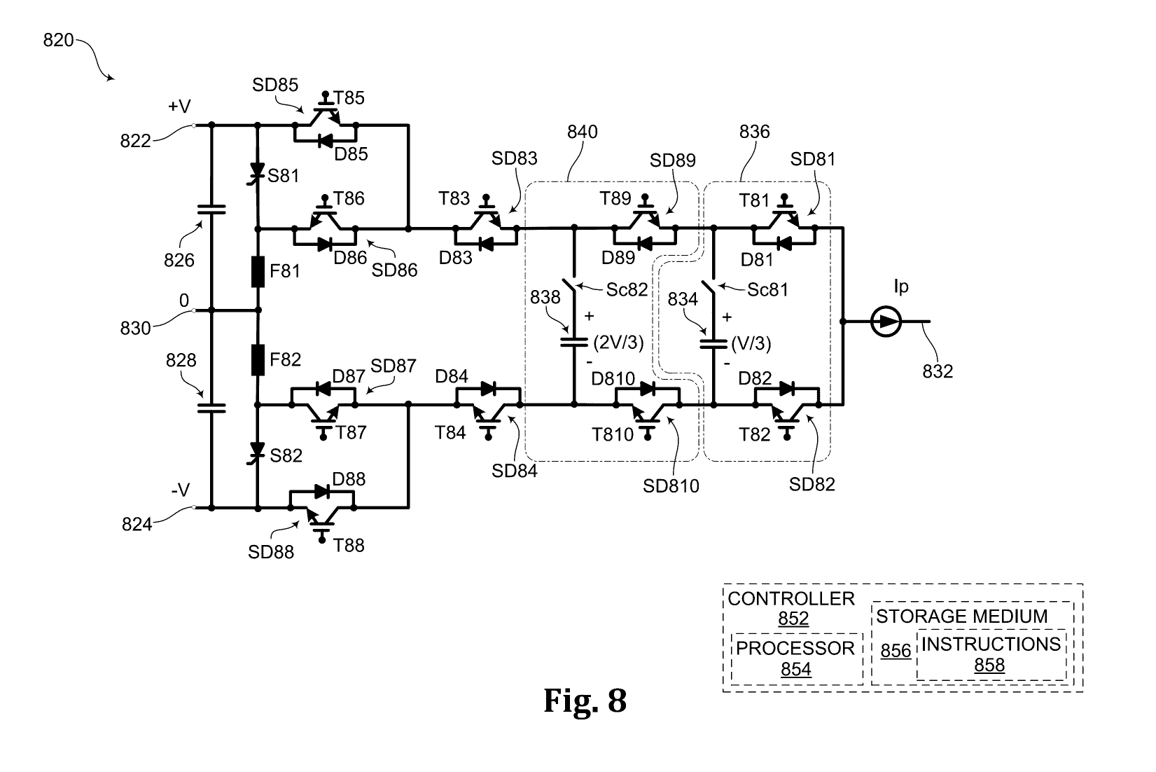

A nonexclusive illustrative example of a 7L-ANPC converter is shown generally at 820 in FIG. 8. Although the 7L-ANPC converter 820 shown in FIG. 8 comprises only a single phase leg, other examples of 7L-ANPC converters may include one or more additional phase legs, each of which may be similar to the 7L-ANPC converter 820, or m examples of the 7L-ANPC converter 820 may be incorporated into an m-phase converter. Unless otherwise specified, the 7L-ANPC converter 820 may, but is not required to, contain at least one of the structures, components, functionalities, and/or variations described, illustrated, and/or incorporated herein.

In the illustrated example, the 7L-ANPC converter 820 includes upper and lower DC links 822, 824; upper and lower DC link capacitors 826, 828; a neutral point 830; a converter output 832; a first two-level cell 836 that is connected to the converter output 832; a second two-level cell 840 that is connected to the first two-level cell 836; first and second switches S81, S82; first and second circuit breaking elements F81, F82; and a plurality of switching devices SD81, SD82, SD83, SD84, SD85, SD86, SD87, SD88, SD89 and SD810. As shown in FIG. 8, the switching device SD86 is the upper active neutral clamp switching device, and the switching device SD87 is the lower active neutral clamp switching device. The first two-level cell 836 comprises the switching devices SD81 and SD82, a first floating capacitor 834 and a first bidirectional switch Sc81. The second two-level cell 840 comprises the switching devices SD89 and SD810, a second floating capacitor 838 and a second bidirectional switch Sc82.

In the 7L-ANPC converter 820, the upper DC link 822 corresponds to a positive DC input voltage (+V) relative to the neutral point 830, while the lower DC link 824 corresponds to a negative DC input voltage (−V) relative to the neutral point 830. The “upper” side of the 7L-ANPC converter 820 comprises the upper DC link 822, the upper DC link capacitor 826, the neutral point 830, the first switch S81, the first circuit breaking element F81, and the switching devices SD81, SD83, SD85, SD86 and SD89. The “lower” side of the 7L-ANPC converter 820 comprises the lower DC link 824, the lower DC link capacitor 828, the neutral point 830, the second switch S82, the second circuit breaking element F82, and the switching devices SD82, SD84, SD87, SD88 and SD810.

As shown in FIG. 8, each of the plurality of switching devices SD81-SD810 of the illustrated 7L-ANPC converter 820 may respectively comprise a corresponding IGBT T81-T810 and a corresponding anti-parallel freewheeling diode D81-D810.

The various components of the 7L-ANPC converter 820 are connected together as shown in FIG. 8. Unless otherwise specified, the connections between the various components of the 7L-ANPC converter 820 may be the same as those set forth above with regard to the corresponding components of the 5L-ANPC converter 420 illustrated in FIG. 4. Furthermore, the connections of the various switching devices of the 7L-ANPC converter 820 are described below with reference to the collector and emitter terminals of the corresponding IGBTs and with the understanding that, if power semiconductor switching devices or active elements other than IGBTs are used, the references below to “collector” and “emitter” would be changed to the appropriate corresponding terminal of such other active elements.

Within the second two-level cell 840, the second bidirectional switch Sc82 and the second floating capacitor 838 are connected in series between the collector of the upper switching device of the second two-level cell 840 (switching device SD89) and the emitter of the lower switching device of the second two-level cell 840 (switching device SD810). The emitter of the switching device SD89 is connected to the collector of the upper switching device of the first two-level cell 836 (switching device SD81), while the collector of the switching device SD89 is connected to the emitter of switching device SD83. The collector of the switching device SD810 is connected to the emitter of the lower switching device of the first two-level cell 836 (switching device SD82), while the emitter of the switching device SD810 is connected to the collector of the switching device SD84.

The first and second bidirectional switches Sc81, Sc82 may be any suitable type of switch that may selectively pass current in either direction, such as a semiconductor device with low losses, such as the bidirectional switch 570 shown in FIG. 5 or an RB-IGBT.

In some examples, the 7L-ANPC converter 820 may be associated with or include a suitable controller, such as the nonexclusive illustrative example controller 852 shown in FIG. 8, which includes at least one processor 854, at least one non-transitory computer readable storage medium 856 and a plurality of machine-readable instructions 858 stored on the storage medium 856 and configured to be executed by the at least one computer processor 854 such that the controller 852 may send appropriate control signals to various ones of the switching devices SD81-SD810; the first and second switches S81, S82 and/or the first and second bidirectional switches Sc81, Sc82, so as to operate the 7L-ANPC converter 820.

The 7L-ANPC converter 820 may provide a fault-tolerant topology having a tolerance with regard to short-failures or short-failure conditions of one or more of its switching devices SD81-SD810 in a manner generally similar to that discussed above with regard to short-failures of the switching devices in the 5L-ANPC converter 420 shown in FIG. 4.

As may be understood, the topology of the 5L-ANPC 420 of FIG. 4 or the 7L-ANPC converter 820 of FIG. 8 may be extended to provide an nL-ANPC, where n is equal to 9 or more, through the addition of one or more additional two level cells.

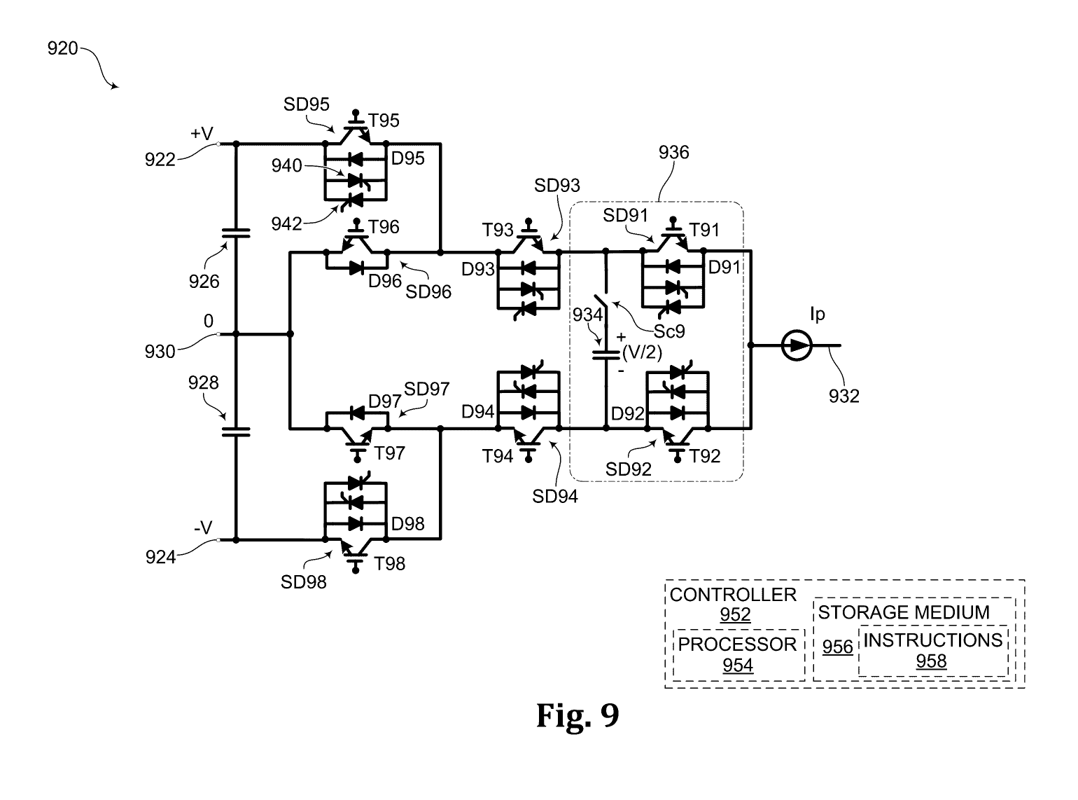

Another nonexclusive illustrative example of a 5L-ANPC converter is shown generally at 920 in FIG. 9. Although the 5L-ANPC converter 920 shown in FIG. 9 comprises only a single phase leg, other examples of 5L-ANPC converters may include one or more additional phase legs, each of which may be similar to the 5L-ANPC converter 920, or m examples of the 5L-ANPC converter 920 may be incorporated into an m-phase converter. Unless otherwise specified, the 5L-ANPC converter 920 may, but is not required to, contain at least one of the structures, components, functionalities, and/or variations described, illustrated, and/or incorporated herein.

In the illustrated example, the 5L-ANPC converter 920 includes upper and lower DC links 922, 924; upper and lower DC link capacitors 926, 928; a neutral point 930; a converter output 932; a two-level cell 936 that is connected to the converter output 932; and a plurality of switching devices SD91, SD92, SD93, SD94, SD95, SD96, SD97 and SD98. As shown in FIG. 9, the switching device SD96 is the upper active neutral clamp switching device that is coupled to the neutral point 930, and the switching device SD97 is the lower active neutral clamp switching device that is coupled to the neutral point 930.

The two-level cell 936 comprises the switching devices SD91 and SD92, a floating capacitor 934 and a bidirectional switch Sc9 that is connected in series with the floating capacitor 934. The bidirectional switch Sc9 may be any suitable type of switch that may selectively pass current in either direction, such as a semiconductor device with low losses, such as the bidirectional switch 570 shown in FIG. 5 or an RB-IGBT.

In the 5L-ANPC converter 920, the upper DC link 922 corresponds to a positive DC input voltage (+V) relative to the neutral point 930, while the lower DC link 924 corresponds to a negative DC input voltage (−V) relative to the neutral point 930. The “upper” side of the 5L-ANPC converter 920 comprises the upper DC link 922, the upper DC link capacitor 926, the neutral point 930, and the switching devices SD91, SD93, SD95 and SD96. The “lower” side of the 5L-ANPC converter 920 comprises the lower DC link 924, the lower DC link capacitor 928, the neutral point 930, and the switching devices SD92, SD94, SD97 and SD98.

As shown in FIG. 9, each of the plurality of switching devices SD91-SD98 of the illustrated 5L-ANPC converter 920 may respectively comprise a corresponding IGBT T91-T98 and a corresponding anti-parallel freewheeling diode D91-D98. As further shown in FIG. 9, the plurality of switching devices, other than the upper and lower active neutral clamp switching devices, (i.e., SD91, SD92, SD93, SD94, SD95 and SD98) may each include a suitable bidirectional switch, such as a mechanical switch or, as shown in FIG. 9, a pair of oppositely-oriented thyristors connected in parallel therewith. For example, the switching device SD95 may comprise a first or parallel-oriented thyristor 940 and a second or anti-parallel-oriented thyristor 942. The oppositely-oriented thyristors may comprise a semiconductor-controlled rectifier or, in some examples, a gate turn-off thyristor.

The various components of the 5L-ANPC converter 920 are connected together as shown in FIG. 9. Unless otherwise specified, the connections between the various components of the 5L-ANPC converter 920 may be the same as those set forth above with regard to the corresponding components of the 5L-ANPC converter 420 illustrated in FIG. 4. Furthermore, the connections of the various switching devices of the 5L-ANPC converter 920 are described below with reference to the collector and emitter terminals of the corresponding IGBTs and with the understanding that, if power semiconductor switching devices or active elements other than IGBTs are used, the references below to “collector” and “emitter” would be changed to the appropriate corresponding terminal of such other active elements.

Within the two-level cell 936, the bidirectional switch Sc9 and the floating capacitor 934 are connected in series between the collector of the upper switching device of the two-level cell 936 (switching device SD91) and the emitter of the lower switching device of the two-level cell 936 (switching device SD92). The emitter of switching device SD91 and the collector of switching device SD92 are both connected to the converter output 932.

On the “upper” side of the 5L-ANPC converter 920, the emitter of switching device SD93 is connected to the collector of switching device SD91. The collector of switching device SD93 is connected to both the emitter of switching device SD95 and the collector of switching device SD96. The collector of switching device SD95 is connected to the upper DC link 922. The emitter of the upper active neutral clamp switching device (switching device SD96) is connected to the neutral point 930. The upper DC link capacitor 926 is connected between the upper DC link 922 and the neutral point 930.

On the “lower” side of the 5L-ANPC converter 920, the collector of switching device SD94 is connected to the emitter of switching device SD92. The emitter of switching device SD94 is connected to both the emitter of switching device SD97 and the collector of switching device SD98. The emitter of switching device SD98 is connected to the lower DC link 924. The collector of the lower active neutral clamp switching device (switching device SD97) is connected to the neutral point 930. The lower DC link capacitor 928 is connected between the lower DC link 924 and the neutral point 930.

In some examples, the 5L-ANPC converter 920 may be associated with or include a suitable controller, such as the nonexclusive illustrative example controller 952 shown in FIG. 9, which includes at least one processor 954, at least one non-transitory computer readable storage medium 956 and a plurality of machine-readable instructions 958 stored on the storage medium 956 and configured to be executed by the at least one computer processor 954 such that the controller 952 may send appropriate control signals to various ones of the switching devices SD91-SD98, the bidirectional switch Sc9 and/or the pairs of oppositely-oriented thyristors that are connected in parallel with the switching devices SD91, SD92, SD93, SD94, SD95 and SD98, so as to operate the 5L-ANPC converter 920.

As generally set forth below, the 5L-ANPC converter 920 may provide a fault-tolerant topology having a tolerance with regard to open-failures or open-failure conditions of one or more of its semiconductor switching devices. As used herein, “open-failure” or “open-failure condition” of a semiconductor switching device means that the failed device does not pass current in one or both directions. Thus, if switching device SD95, for example, is subject to an “open-failure” or “open-failure condition,” then either or both the IGBT T95 and the corresponding diode D95 do not pass current. If both the IGBT T95 and the corresponding diode D95 have failed open, then the switching device does not pass current in either direction.

In response to an “open-failure” of one of the switching devices SD91, SD92, SD93, SD94, SD95 and SD98, one or both of the corresponding pair of oppositely-oriented thyristors may be fired to provide a replacement current flow path through the failed switching device, depending on whether the IGBT and/or the diode has/have failed. In some examples, both of the corresponding pair of oppositely-oriented thyristors may be fired regardless of whether the IGBT, the diode or both have failed and/or without detecting or determining whether the IGBT, the diode or both have failed, which may simplify control needs. As may be understood, if the IGBT fails into an open condition and the corresponding thyristor is fired to provide a replacement current flow path, the result is the same as if the switching device had failed into a short condition.

As a nonexclusive illustrative example, if one or both of the IGBT T95 and the diode D95 of the switching device SD95 fail into an open condition, both of the pair of oppositely-oriented thyristors 940, 942 may be fired to provide replacement current flow paths through the switching device SD95, which is then effectively in a short condition. In some examples, if only the IGBT T95 fails into an open condition, only the parallel-oriented thyristor 940 need be fired to provide a replacement current flow path through the switching device SD95, which is then effectively in a short condition. In some examples, if only the diode D95 fails into an open condition, only the anti-parallel-oriented thyristor 942 need be fired to provide a replacement current flow paths through the switching device SD95.

As may be understood, if the IGBT of one of the switching devices SD91, SD93 or SD95 fails open and the corresponding thyristor(s) is/are fired to provide a replacement current flow path, which effectively shorts the switching device, the remaining available switching states for the 5L-ANPC converter 920 would be the same as those listed in Table 610 and discussed above with regard to short-failures of the corresponding switching device, with the bidirectional switch Sc9 being opened/closed as appropriate. For the 5L-ANPC converter 920, the switching devices SD91, SD93, SD95 and SD96 would respectively correspond to SDX1, SDX3, SDX5 and SDX6 in Table 610, while the IGBTs T91-T98 respectively correspond to TX1-TX8 and the bidirectional switch Sc9 corresponds to ScX. Open-failures of one of the switching devices SD92, SD94 or SD98 may be correspondingly addressed to provide the corresponding remaining available switching states. With regard to open-failures of the upper or lower active neutral clamp switching devices (i.e., the switching devices SD96 and SD97), it may be understood that open failures of the switching devices SD96 and SD97 disconnect the corresponding upper or lower active neutral clamp switching device from the neutral point, which has the same effect as closing the first or second switches S41, S42 in the 5L-ANPC converter 420 to open the corresponding first or second circuit breaking element F41, F42 to disconnect the corresponding upper or lower active neutral clamp switching device from the neutral point.

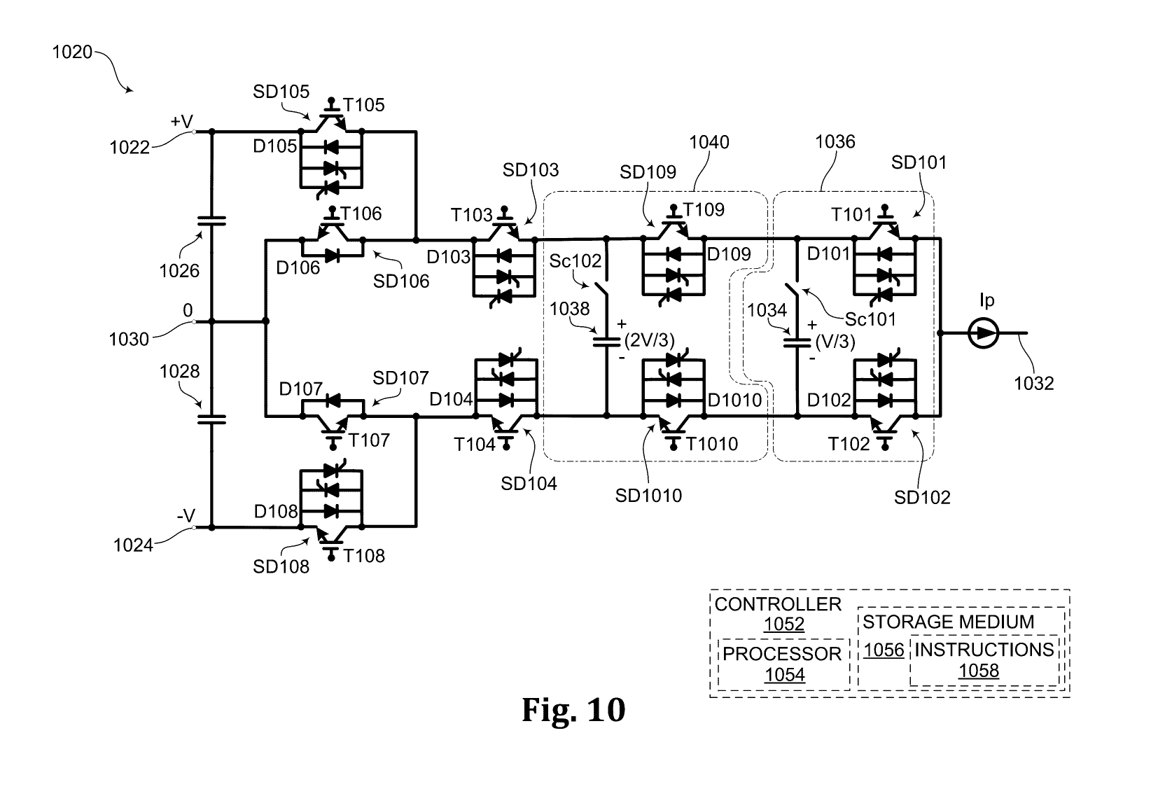

Another nonexclusive illustrative example of a 7L-ANPC converter is shown generally at 1020 in FIG. 10. Although the 7L-ANPC converter 1020 shown in FIG. 10 comprises only a single phase leg, other examples of 7L-ANPC converters may include one or more additional phase legs, each of which may be similar to the 7L-ANPC converter 1020, or m examples of the 7L-ANPC converter 1020 may be incorporated into an m-phase converter. Unless otherwise specified, the 7L-ANPC converter 1020 may, but is not required to, contain at least one of the structures, components, functionalities, and/or variations described, illustrated, and/or incorporated herein.

In the illustrated example, the 7L-ANPC converter 1020 includes upper and lower DC links 1022, 1024; upper and lower DC link capacitors 1026, 1028; a neutral point 1030; a converter output 1032; a first two-level cell 1036 that is connected to the converter output 1032; a second two-level cell 1040 that is connected to the first two-level cell 1036; and a plurality of switching devices SD101, SD102, SD103, SD104, SD105, SD106, SD107, SD108, SD109 and SD1010. As shown in FIG. 10, the switching device SD106 is the upper active neutral clamp switching device, and the switching device SD107 is the lower active neutral clamp switching device. The first two-level cell 1036 comprises the switching devices SD101 and SD102, a first floating capacitor 1034 and a first bidirectional switch Sc101. The second two-level cell 1040 comprises the switching devices SD109 and SD1010, a second floating capacitor 1038 and a second bidirectional switch Sc102.

In the 7L-ANPC converter 1020, the upper DC link 1022 corresponds to a positive DC input voltage (+V) relative to the neutral point 1030, while the lower DC link 1024 corresponds to a negative DC input voltage (−V) relative to the neutral point 1030. The “upper” side of the 7L-ANPC converter 1020 comprises the upper DC link 1022, the upper DC link capacitor 1026, the neutral point 1030, and the switching devices SD101, SD103, SD105, SD106 and SD109. The “lower” side of the 7L-ANPC converter 1020 comprises the lower DC link 1024, the lower DC link capacitor 1028, the neutral point 1030, and the switching devices SD102, SD104, SD107, SD108 and SD1010.

As shown in FIG. 10, each of the plurality of switching devices SD101-SD1010 of the illustrated 7L-ANPC converter 1020 may respectively comprise a corresponding IGBT T101-T1010 and a corresponding anti-parallel freewheeling diode D101-D1010. As further shown in FIG. 10, the plurality of switching devices, other than the upper and lower active neutral clamp switching devices, (i.e., SD101, SD102, SD103, SD104, SD105, SD108, SD109 and SD1010) may each include a suitable bidirectional switch, such as a pair of oppositely-oriented thyristors, connected in parallel therewith.

The various components of the 7L-ANPC converter 1020 are connected together as shown in FIG. 10. Unless otherwise specified, the connections between the various components of the 7L-ANPC converter 1020 may be the same as those set forth above with regard to the corresponding components of the 5L-ANPC converter 920 illustrated in FIG. 9. Furthermore, the connections of the various switching devices of the 7L-ANPC converter 1020 are described below with reference to the collector and emitter terminals of the corresponding IGBTs and with the understanding that, if power semiconductor switching devices or active elements other than IGBTs are used, the references below to “collector” and “emitter” would be changed to the appropriate corresponding terminal of such other active elements.

Within the second two-level cell 1040, the second bidirectional switch Sc102 and the second floating capacitor 1038 are connected in series between the collector of the upper switching device of the second two-level cell 1040 (switching device SD109) and the emitter of the lower switching device of the second two-level cell 1040 (switching device SD1010). The emitter of the switching device SD109 is connected to the collector of the upper switching device of the first two-level cell 1036 (switching device SD101), while the collector of the switching device SD109 is connected to the emitter of switching device SD103. The collector of the switching device SD1010 is connected to the emitter of the lower switching device of the first two-level cell 1036 (switching device SD102), while the emitter of the switching device SD1010 is connected to the collector of the switching device SD104.

The first and second bidirectional switches Sc101, Sc102 may be any suitable type of switch that may selectively pass current in either direction, such as a semiconductor device with low losses, such as the bidirectional switch 570 shown in FIG. 5 or an RB-IGBT.

In some examples, the 7L-ANPC converter 1020 may be associated with or include a suitable controller, such as the nonexclusive illustrative example controller 1052 shown in FIG. 10, which includes at least one processor 1054, at least one non-transitory computer readable storage medium 1056 and a plurality of machine-readable instructions 1058 stored on the storage medium 1056 and configured to be executed by the at least one computer processor 1054 such that the controller 1052 may send appropriate control signals to various ones of the switching devices SD101-SD1010, the first and second bidirectional switches Sc101, Sc102 and/or the pairs of oppositely-oriented thyristors that are connected in parallel with the switching devices SD101, SD102, SD103, SD104, SD105, SD108, SD109 and SD1010, so as to operate the 7L-ANPC converter 1020.

The 7L-ANPC converter 1020 may provide a fault-tolerant topology having a tolerance with regard to open-failures or open-failure conditions of one or more of its switching devices SD101-SD1010 in a manner generally similar to that discussed above with regard to open-failures of the switching devices in the 5L-ANPC converter 920 shown in FIG. 9.

As may be understood, the topology of the 5L-ANPC 920 of FIG. 9 or the 7L-ANPC converter 1020 of FIG. 10 may be extended to provide an nL-ANPC, where n is equal to 9 or more, through the addition of one or more additional two level cells.

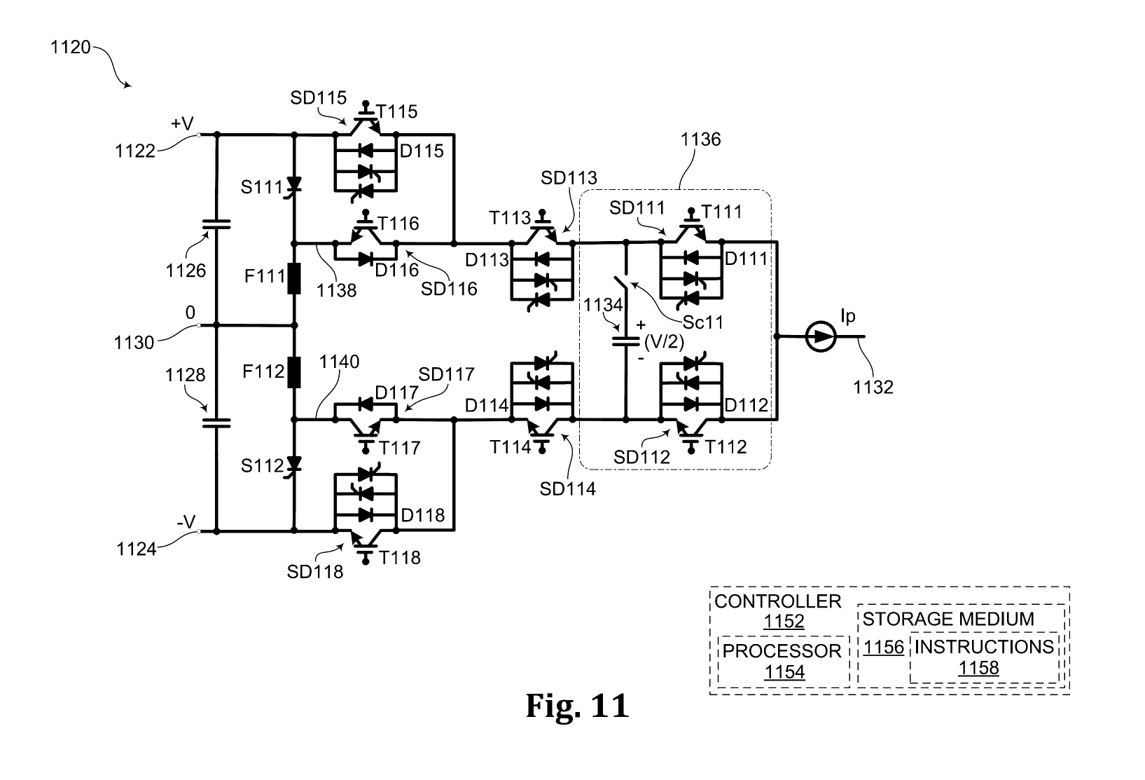

Another nonexclusive illustrative example of a 5L-ANPC converter is shown generally at 1120 in FIG. 11. Although the 5L-ANPC converter 1120 shown in FIG. 11 comprises only a single phase leg, other examples of 5L-ANPC converters may include one or more additional phase legs, each of which may be similar to the 5L-ANPC converter 1120, or m examples of the 5L-ANPC converter 1120 may be incorporated into an m-phase converter. Unless otherwise specified, the 5L-ANPC converter 1120 may, but is not required to, contain at least one of the structures, components, functionalities, and/or variations described, illustrated, and/or incorporated herein. As generally set forth below, the 5L-ANPC converter 1120 may provide a fault-tolerant topology having a tolerance with regard to either open-failures or short-failures of one or more of its semiconductor switching devices.

In the illustrated example, the 5L-ANPC converter 1120 includes upper and lower DC links 1122, 1124; upper and lower DC link capacitors 1126, 1128; a neutral point 1130; a converter output 1132; a two-level cell 1136 that is connected to the converter output 1132; first and second switches S111, S112; first and second circuit breaking elements F111, F112; and a plurality of switching devices SD111, SD112, SD113, SD114, SD115, SD116, SD117 and SD118. As shown in FIG. 11, the switching device SD116 is the upper active neutral clamp switching device, and the switching device SD117 is the lower active neutral clamp switching device.

The two-level cell 1136 comprises the switching devices SD111 and SD112, a floating capacitor 1134 and a bidirectional switch Sc11 that is connected in series with the floating capacitor 1134. The bidirectional switch Sc11 may be any suitable type of switch that may selectively pass current in either direction, such as a semiconductor device with low losses, such as the bidirectional switch 570 shown in FIG. 5 or an RB-IGBT.

The first and second switches S111, S112 may be any suitable type of normally open switch. In some examples, at least one of the first and second switches S111, S112 may comprise a thyristor, such as a gate turn-off thyristor, or a semiconductor-controlled rectifier.

The first and second circuit breaking elements F111, F112 may be any suitable type of circuit breaking element. In some examples, at least one of the first and second circuit breaking elements F111, F112 may comprise a fuse.

In the 5L-ANPC converter 1120, the upper DC link 1122 corresponds to a positive DC input voltage (+V) relative to the neutral point 1130, while the lower DC link 1124 corresponds to a negative DC input voltage (−V) relative to the neutral point 1130. The “upper” side of the 5L-ANPC converter 1120 comprises the upper DC link 1122, the upper DC link capacitor 1126, the neutral point 1130, and the switching devices SD111, SD113, SD115 and SD116. The “lower” side of the 5L-ANPC converter 1120 comprises the lower DC link 1124, the lower DC link capacitor 1128, the neutral point 1130, and the switching devices SD112, SD114, SD117 and SD118.

As shown in FIG. 11, each of the plurality of switching devices SD111-SD118 of the illustrated 5L-ANPC converter 1120 may respectively comprise a corresponding IGBT T111-T118 and a corresponding anti-parallel freewheeling diode D111-D118. As further shown in FIG. 11, the plurality of switching devices, other than the upper and lower active neutral clamp switching devices, (i.e., SD111, SD112, SD113, SD114, SD115 and SD118) may each include a suitable bidirectional switch, such as a mechanical switch or a pair of oppositely-oriented thyristors connected in parallel therewith. The oppositely-oriented thyristors may comprise a semiconductor-controlled rectifier or, in some examples, a gate turn-off thyristor.

The various components of the 5L-ANPC converter 1120 are connected together as shown in FIG. 11. Unless otherwise specified, the connections between the various components of the 5L-ANPC converter 1120 may be the same as those set forth above with regard to the corresponding components of the 5L-ANPC converter 420 and/or the corresponding components of the 5L-ANPC converter 920. Furthermore, the connections of the various switching devices of the 5L-ANPC converter 1120 are described below with reference to the collector and emitter terminals of the corresponding IGBTs and with the understanding that, if power semiconductor switching devices or active elements other than IGBTs are used, the references below to “collector” and “emitter” would be changed to the appropriate corresponding terminal of such other active elements.

Within the two-level cell 1136, the bidirectional switch Sc11 and the floating capacitor 1134 are connected in series between the collector of the upper switching device of the two-level cell 1136 (switching device SD111) and the emitter of the lower switching device of the two-level cell 1136 (switching device SD112). The emitter of switching device SD111 and the collector of switching device SD112 are both connected to the converter output 1132.

On the “upper” side of the 5L-ANPC converter 1120, the emitter of switching device SD113 is connected to the collector of switching device SD111. The collector of switching device SD113 is connected to both the emitter of switching device SD115 and the collector of switching device SD116. The collector of switching device SD115 is connected to the upper DC link 1122. The emitter (first terminal 1138) of the upper active neutral clamp switching device (switching device SD116) is connected to the neutral point 1130 by the first circuit breaking element F111 and to the upper DC link 1122 by the first switch S111. The upper DC link capacitor 1126 is connected between the upper DC link 1122 and the neutral point 1130. The first switch S111 and the first circuit breaking element F111 are connected in series between the upper DC link 1122 and the neutral point 1130, with the first switch S111 and the first circuit breaking element F111 being together connected in parallel with the upper DC link capacitor 1126.

On the “lower” side of the 5L-ANPC converter 1120, the collector of switching device SD114 is connected to the emitter of switching device SD112. The emitter of switching device SD114 is connected to both the emitter of switching device SD117 and the collector of switching device SD118. The emitter of switching device SD118 is connected to the lower DC link 1124. The collector (second terminal 1140) of the lower active neutral clamp switching device (switching device SD117) is connected to the neutral point 1130 by the second circuit breaking element F112 and to the lower DC link 1124 by the second switch S112. The lower DC link capacitor 1128 is connected between the lower DC link 1124 and the neutral point 1130. The second switch S112 and the second circuit breaking element F112 are connected in series between the lower DC link 1124 and the neutral point 1130, with the second switch S112 and the second circuit breaking element F112 being together connected in parallel with the lower DC link capacitor 1128.

In some examples, the 5L-ANPC converter 1120 may be associated with or include a suitable controller, such as the nonexclusive illustrative example controller 1152 shown in FIG. 11, which includes at least one processor 1154, at least one non-transitory computer readable storage medium 1156 and a plurality of machine-readable instructions 1158 stored on the storage medium 1156 and configured to be executed by the at least one computer processor 1154 such that the controller 1152 may send appropriate control signals to various ones of the switching devices SD111-SD118; the first and second switches S111, S112, the bidirectional switch Sc11 and/or the pairs of oppositely-oriented thyristors that are connected in parallel with the switching devices SD111, SD112, SD113, SD114, SD115 and S118, so as to operate the 5L-ANPC converter 1120.

As may be understood, the 5L-ANPC converter 1120 may generally combine the short-failure tolerance of the 5L-ANPC converter 420 with the open-failure tolerance of the 5L-ANPC converter 920. After the failed switching device has been identified, along with identification of whether the switching device failed in short or open, the 5L-ANPC converter 1120 can continue operation using the modified switching states discussed above.

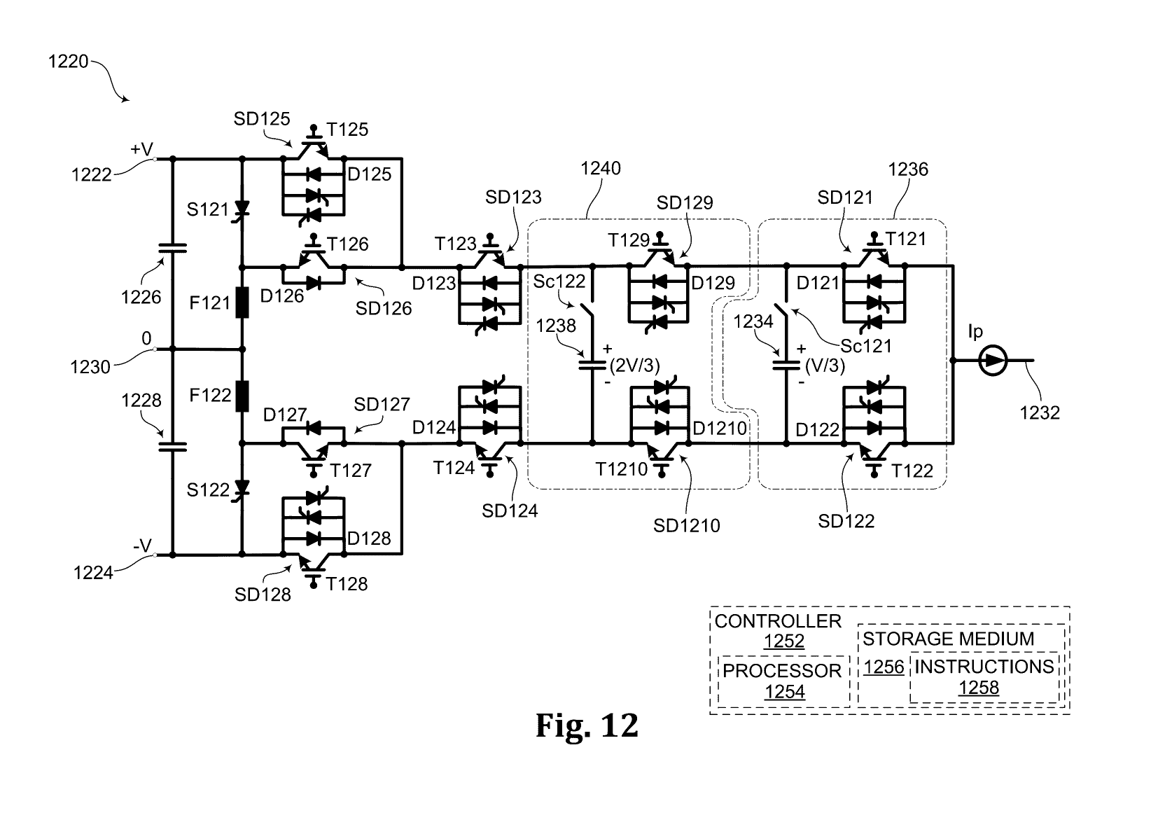

Another nonexclusive illustrative example of a 7L-ANPC converter is shown generally at 1220 in FIG. 12. Although the 7L-ANPC converter 1220 shown in FIG. 12 comprises only a single phase leg, other examples of 7L-ANPC converters may include one or more additional phase legs, each of which may be similar to the 7L-ANPC converter 1220, or m examples of the 7L-ANPC converter 1220 may be incorporated into an m-phase converter. Unless otherwise specified, the 7L-ANPC converter 1220 may, but is not required to, contain at least one of the structures, components, functionalities, and/or variations described, illustrated, and/or incorporated herein.

In the illustrated example, the 7L-ANPC converter 1220 includes upper and lower DC links 1222, 1224; upper and lower DC link capacitors 1226, 1228; a neutral point 1230; a converter output 1232; a first two-level cell 1236 that is connected to the converter output 1232; a second two-level cell 1240 that is connected to the first two-level cell 1236; first and second switches S121, S122; first and second circuit breaking elements F121, F122; and a plurality of switching devices SD121, SD122, SD123, SD124, SD125, SD126, SD127, SD128, SD129 and SD1210. As shown in FIG. 12, the switching device SD126 is the upper active neutral clamp switching device, and the switching device SD127 is the lower active neutral clamp switching device. The first two-level cell 1236 comprises the switching devices SD121 and SD122, a first floating capacitor 1234 and a first bidirectional switch Sc121. The second two-level cell 1240 comprises the switching devices SD129 and SD1210, a second floating capacitor 1238 and a second bidirectional switch Sc122.

In the 7L-ANPC converter 1220, the upper DC link 1222 corresponds to a positive DC input voltage (+V) relative to the neutral point 1230, while the lower DC link 1224 corresponds to a negative DC input voltage (−V) relative to the neutral point 1230. The “upper” side of the 7L-ANPC converter 1220 comprises the upper DC link 1222, the upper DC link capacitor 1226, the neutral point 1230, the first switch S121, the first circuit breaking element F121, and the switching devices SD121, SD123, SD125, SD126 and SD129. The “lower” side of the 7L-ANPC converter 1220 comprises the lower DC link 1224, the lower DC link capacitor 1228, the neutral point 1230, the second switch S122, the second circuit breaking element F122, and the switching devices SD122, SD124, SD127, SD128 and SD1210.

As shown in FIG. 12, each of the plurality of switching devices SD121-SD1210 of the illustrated 7L-ANPC converter 1220 may respectively comprise a corresponding IGBT T121-T1210 and a corresponding anti-parallel freewheeling diode D121-D1210. As further shown in FIG. 12, the plurality of switching devices, other than the upper and lower active neutral clamp switching devices, (i.e., SD121, SD122, SD123, SD124, SD125, SD128, SD129 and SD1210) may each include a suitable bidirectional switch, such as a pair of oppositely-oriented thyristors, connected in parallel therewith.

The various components of the 7L-ANPC converter 1220 are connected together as shown in FIG. 12. Unless otherwise specified, the connections between the various components of the 7L-ANPC converter 1220 may be the same as those set forth above with regard to the corresponding components of the 5L-ANPC converter 1120 illustrated in FIG. 11, the corresponding components of the 7L-ANPC converter 820 illustrated in FIG. 8 and/or the corresponding components of the 7L-ANPC converter 1020 illustrated in FIG. 10. Furthermore, the connections of the various switching devices of the 7L-ANPC converter 1220 are described below with reference to the collector and emitter terminals of the corresponding IGBTs and with the understanding that, if power semiconductor switching devices or active elements other than IGBTs are used, the references below to “collector” and “emitter” would be changed to the appropriate corresponding terminal of such other active elements.

Within the second two-level cell 1240, the second bidirectional switch Sc122 and the second floating capacitor 1238 are connected in series between the collector of the upper switching device of the second two-level cell 1240 (switching device SD129) and the emitter of the lower switching device of the second two-level cell 1240 (switching device SD1210). The emitter of the switching device SD129 is connected to the collector of the upper switching device of the first two-level cell 1236 (switching device SD121), while the collector of the switching device SD129 is connected to the emitter of switching device SD123. The collector of the switching device SD1210 is connected to the emitter of the lower switching device of the first two-level cell 1236 (switching device SD122), while the emitter of the switching device SD1210 is connected to the collector of the switching device SD124.

The first and second bidirectional switches Sc121, Sc122 may be any suitable type of switch that may selectively pass current in either direction, such as a semiconductor device with low losses, such as the bidirectional switch 570 shown in FIG. 5 or an RB-IGBT.

In some examples, the 7L-ANPC converter 1220 may be associated with or include a suitable controller, such as the nonexclusive illustrative example controller 1252 shown in FIG. 12, which includes at least one processor 1254, at least one non-transitory computer readable storage medium 1256 and a plurality of machine-readable instructions 1258 stored on the storage medium 1256 and configured to be executed by the at least one computer processor 1254 such that the controller 1252 may send appropriate control signals to various ones of the switching devices SD121-SD1210; the first and second switches S121, S122, the first and second bidirectional switches Sc121, Sc122 and/or the pairs of oppositely-oriented thyristors that are connected in parallel with the switching devices SD121, SD122, SD123, SD124, SD125, SD128, SD129 and SD1210, so as to operate the 7L-ANPC converter 1220.

The 7L-ANPC converter 1220 may provide a fault-tolerant topology having a tolerance with regard to either open-failures or short-failures of one or more of its switching devices SD121-SD1210 in a manner generally similar to that discussed above with regard to either open-failures or short-failures of the switching devices in the 5L-ANPC converter 1120 shown in FIG. 11.

As may be understood, the topology of the 5L-ANPC 1120 of FIG. 11 or the 7L-ANPC converter 1220 of FIG. 12 may be extended to provide an nL-ANPC, where n is equal to 9 or more, through the addition of one or more additional two level cells.

As may be understood, some examples of ANPCs, such as some examples of the various 5L-ANPCs, 7L-ANPCs and nL-ANPCs disclosed herein, may be designed and/or built with certain ones of the switching devices being selected as tending to fail into a short-failure or tending to fail into an open failure. Accordingly, a converter may, in some examples, include switching devices tending to fail into a short-failure in positions where the topology is configured to address a short-failure of that switching device and/or the converter may include switching devices tending to fail into an open-failure in positions where the topology is configured to address an open-failure of that switching device.

The following paragraphs describe nonexclusive illustrative examples of methods, which may be computer implemented, such as where a computer processor performs some or all of the methods, for operating a five or more level ANPC converter, using the concepts and components disclosed herein. The actions of the disclosed methods may be performed in the order in which they are presented herein. However, unless the context indicates otherwise, it is within the scope of this disclosure for the actions, either alone or in various combinations, to be performed before and/or after any of the other actions. It is further within the scope of this disclosure for the disclosed methods to omit one or more of the disclosed actions and/or to include one or more actions in addition to those disclosed herein.

Methods for operating a five or more level ANPC converter; such as one that includes upper and lower DC links, a neutral point, a converter output, at least one two-level cell connected to the converter output, a plurality of switching devices including upper and lower active neutral clamp switching devices coupled to the neutral point, the plurality of switching devices including a plurality of other switching devices in addition to the upper and lower active neutral clamp switching devices, and each of the at least one two-level cell comprises a floating capacitor and a bidirectional switch connected in series with the floating capacitor; may include identifying at least one of the plurality of switching devices as having a failure; and at least one of (a) selectively controlling the bidirectional switch to selectively disconnect the floating capacitor; (b) disconnecting the upper active neutral clamp switching device from the neutral point if the failure is a short failure of the upper active neutral clamp switching device; (c) disconnecting the lower active neutral clamp switching device from the neutral point if the failure is a short failure of the lower active neutral clamp switching device; and (d) short-circuiting the identified at least one of the plurality of switching devices if the failure is an open failure of at least one of the plurality of other switching devices.

In some examples, such as where the upper active neutral clamp switching device has a first terminal, a first switch is connected between the upper DC link and the first terminal, a first fuse is connected between the first terminal and the neutral point, the lower active neutral clamp switching device has a second terminal, a second switch is connected between the lower DC link and the second terminal, and a second fuse is connected between the second terminal and the neutral point, the methods may include closing the first switch to blow the first fuse to disconnect the upper active neutral clamp switching device from the neutral point and/or closing the second switch to blow the second fuse to disconnect the lower active neutral clamp switching device from the neutral point.

In some examples, such as where a pair of thyristors is connected in parallel with each of the plurality of other switching devices, the methods may include firing the pair of thyristors connected in parallel with the identified at least one of the plurality of switching devices to short-circuit the identified at least one of the plurality of switching devices that was identified as having an open failure.

In some examples, the methods may include selectively controlling the bidirectional switch to selectively disconnect the floating capacitor to provide a selected voltage at the converter output.

Other nonexclusive illustrative examples of methods of operating a five or more level ANPC converter may include detecting a short failure in at least one of the upper and lower active neutral clamp switching devices and a plurality of other switching devices, and selectively controlling a bidirectional switch to selectively disconnect a floating capacitor. If the short failure is a short failure of the upper active neutral clamp switching device, the method may include disconnecting the upper active neutral clamp switching device from the neutral point, such as by closing a switch to blow a fuse. If the short failure is a short failure of the lower active neutral clamp switching device, the method may include disconnecting the lower active neutral clamp switching device from the neutral point, such as by closing a switch to blow a fuse.

Other nonexclusive illustrative examples of methods of operating a five or more level ANPC converter may include identifying at least one of the plurality of switching devices, such as one other than the upper and lower active neutral clamp switching devices, as having an open failure, short-circuiting the identified at least one of the plurality of other switching devices, such as by firing a pair of thyristors connected in parallel with the identified at least one of the plurality of other switching devices, and selectively controlling the bidirectional switch to selectively disconnect the floating capacitor.

The disclosed methods and systems may at least partially be embodied as or take the form of the methods and systems previously described, as well as of a transitory or non-transitory computer readable storage medium having a plurality of machine- or computer-readable instructions stored thereon that, when executed by a computer processor, carry out operations of the disclosed systems and/or perform the disclosed methods as computer-implemented or computer-executed methods. The computer-readable storage medium may be any medium that can contain, store, communicate, propagate, or transport the instructions for use by or in connection with the instruction executing processor, system, apparatus, or device and may, by way of example but without limitation, be an electronic, magnetic, optical, electromagnetic, infrared, or semiconductor system, apparatus, device, or propagation medium or other suitable medium upon which the program is recorded. More specific examples (a non-exhaustive list) of such a computer-readable medium may include: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Computer program code or instructions for carrying out operations of the disclosed methods and systems may be written in any suitable programming language provided it allows achieving the previously described technical results. The instructions may be configured for execution on any system or device, or combination of systems or devices, having sufficient processing power and access to the required data.

As used herein the term “configured” should be interpreted to mean that the identified elements, components, or other subject matter are selected, created, implemented, utilized, designed, modified, adjusted and/or intended to perform the indicated action and/or to perform, operate, behave and/or react in the indicated manner.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein. Similarly, recitation in the disclosure and/or the claims of “a,” “a first” or “the” element, or the equivalent thereof, should be understood to include incorporation of one or more such elements, neither requiring nor excluding two or more such elements, unless the context clearly indicates otherwise. As used herein, the terms “having”, “containing”, “including”, “comprising” and the like are open ended terms that indicate the presence of stated elements or features, but do not preclude additional elements or features.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

What is claimed is:

1. A five or more level active neutral-point-clamped (ANPC) converter, comprising:
upper and lower DC links, a neutral point and a converter output;
at least one two-level cell connected to the converter output, wherein each of the at least one two-level cell comprises a floating capacitor and a bidirectional switch connected in series with the floating capacitor;
an upper active neutral clamp switching device having a first terminal, wherein a first switch is connected between the upper DC link and the first terminal, and a first circuit breaking element is connected between the first terminal and the neutral point; and
a lower active neutral clamp switching device having a second terminal, wherein a second switch is connected between the lower DC link and the second terminal, and a second circuit breaking element is connected between the second terminal and the neutral point.

2. The five or more level ANPC converter of claim 1, wherein the first terminal is an emitter of the upper active neutral clamp switching device, and the second terminal is a collector of the lower active neutral clamp switching device.

3. The five or more level ANPC converter of claim 2, comprising a plurality of switching devices, wherein the plurality of switching devices includes the upper and lower active neutral clamp switching devices, and each of the plurality of switching devices comprises an insulated-gate bipolar transistor (IGBT).

4. The five or more level ANPC converter of claim 1, wherein at least one of the first and second switches comprises a thyristor, and at least one of the first and second circuit breaking elements comprises a fuse.

5. The five or more level ANPC converter of claim 1, wherein the first switch and the first circuit breaking element are connected in series between the upper DC link and the neutral point, and the second switch and the second circuit breaking element are connected in series between the lower DC link and the neutral point.

6. The five or more level ANPC converter of claim 5, comprising:
an upper DC link capacitor connected between the upper DC link and the neutral point, wherein the first switch and the first circuit breaking element are together connected in parallel with the upper DC link capacitor; and
a lower DC link capacitor connected between the lower DC link and the neutral point, wherein second switch and the second circuit breaking element are together connected in parallel with the lower DC link capacitor.

7. The five or more level ANPC converter of claim 1, wherein the bidirectional switch comprises two insulated-gate bipolar transistors (IGBTs) connected in opposite directions, wherein each of the IGBTs includes an anti-parallel diode.

8. The five or more level ANPC converter of claim 1, comprising a plurality of other switching devices in addition to the upper and lower active neutral clamp switching devices, wherein a pair of thyristors is connected in parallel with each of the plurality of other switching devices.

9. The five or more level ANPC converter of claim 1, comprising a controller, wherein the controller is configured to at least one of:
close the first switch in response to a short failure of the upper active neutral clamp switching device to open the first circuit breaking element;
close the second switch in response to a short failure of the lower active neutral clamp switching device to open the second circuit breaking element; and
selectively control the bidirectional switch to selectively disconnect the floating capacitor to provide a selected voltage at the converter output.

10. A five or more level active neutral-point-clamped (ANPC) converter, comprising:
upper and lower DC links, a neutral point and a converter output;
at least one two-level cell connected to the converter output, wherein each of the at least one two-level cell comprises a floating capacitor and a first bidirectional switch connected in series with the floating capacitor;
upper and lower active neutral clamp switching devices each coupled to the neutral point; and
a plurality of other switching devices in addition to the upper and lower active neutral clamp switching devices, wherein a second bidirectional switch is connected in parallel with each of the plurality of other switching devices.

11. The five or more level ANPC converter of claim 10, wherein each of the upper and lower active neutral clamp switching devices and the plurality of other switching devices comprises an insulated-gate bipolar transistor (IGBT).

12. The five or more level ANPC converter of claim 10, wherein the first bidirectional switch comprises two insulated-gate bipolar transistors (IGBTs) connected in opposite directions, wherein each of the IGBTs includes an anti-parallel diode.

13. The five or more level ANPC converter of claim 10, wherein the upper active neutral clamp switching device has a first terminal, the lower active neutral clamp switching device has a second terminal, and the converter comprises:
a first switch connected between the upper DC link and the first terminal;
a first fuse connected between the first terminal and the neutral point;
a second switch connected between the lower DC link and the second terminal; and
a second fuse connected between the second terminal and the neutral point.

14. The five or more level ANPC converter of claim 13, wherein at least one of the first and second switches comprises a thyristor.

15. The five or more level ANPC converter of claim 13, comprising:
an upper DC link capacitor connected between the upper DC link and the neutral point, wherein the first switch and the first fuse are connected in series between the upper DC link and the neutral point and the first switch and the first fuse are connected in parallel with the upper DC link capacitor; and
a lower DC link capacitor connected between the lower DC link and the neutral point, wherein the second switch and the second fuse are connected in series between the lower DC link and the neutral point and the second switch and the second fuse are connected in parallel with the lower DC link capacitor.

16. The five or more level ANPC converter of claim 10, wherein the second bidirectional switch comprises a pair of thyristors.

17. The five or more level ANPC converter of claim 16, comprising a controller, wherein the controller is configured to at least one of:
identify at least one of the plurality of other switching devices as having an open failure;
fire the pair of thyristors connected in parallel with the identified at least one of the plurality of other switching devices; and
selectively control the bidirectional switch to selectively disconnect the floating capacitor to provide a selected voltage at the converter output.

18. A method of operating a five or more level active neutral-point-clamped (ANPC) converter having upper and lower DC links, a neutral point, a converter output, at least one two-level cell connected to the converter output, a plurality of switching devices including upper and lower active neutral clamp switching devices coupled to the neutral point, the plurality of switching devices including a plurality of other switching devices in addition to the upper and lower active neutral clamp switching devices, and each of the at least one two-level cell comprises a floating capacitor and a bidirectional switch connected in series with the floating capacitor, the method comprising:
identifying at least one of the plurality of switching devices as having a failure; and
at least one of:
selectively controlling the bidirectional switch to selectively disconnect the floating capacitor;
disconnecting the upper active neutral clamp switching device from the neutral point if the failure is a short failure of the upper active neutral clamp switching device;
disconnecting the lower active neutral clamp switching device from the neutral point if the failure is a short failure of the lower active neutral clamp switching device; and
short-circuiting the identified at least one of the plurality of switching devices if the failure is an open failure of at least one of the plurality of other switching devices.

19. The method of claim 18, wherein:
the upper active neutral clamp switching device has a first terminal, a first switch is connected between the upper DC link and the first terminal, and a first fuse is connected between the first terminal and the neutral point;
the lower active neutral clamp switching device has a second terminal, a second switch is connected between the lower DC link and the second terminal, and a second fuse is connected between the second terminal and the neutral point;
disconnecting the upper active neutral clamp switching device from the neutral point comprises closing the first switch to blow the first fuse; and
disconnecting the lower active neutral clamp switching device from the neutral point comprises closing the second switch to blow the second fuse.

20. The method of claim 18, wherein a pair of thyristors is connected in parallel with each of the plurality of other switching devices, and short-circuiting the identified at least one of the plurality of switching devices comprises firing the pair of thyristors connected in parallel with the identified at least one of the plurality of switching devices.

21. The method of claim 18 embodied as a plurality of machine-readable instructions stored on a non-transitory computer readable storage medium and configured to be executed by at least one computer processor to perform the method to operate a five or more level ANPC converter.
